(19) United States
(12) Patent Application Publication
(10) Pub. No.: US 2026/0321904 A1
(43) Pub. Date: Oct. 15, 2026

(54) Rechargeable Battery Pack for Supplying Electrical Drive Power to an Electrically Driven Piece of Work Equipment, and System Comprising the Rechargeable Battery Pack

(71) Applicant: Andreas Stihl AG & Co. KG, Waiblingen (DE)

(72) Inventor: Tobias WUERSCHUM, Remseck (DE)

(21) Appl. No.: 19/645,026

(22) Filed: Apr. 10, 2026

(30) Foreign Application Priority Data
Apr. 11, 2025 (DE) 10 2025 114 359.5

(51) Int. Cl. H01M 50/519; H01M 10/42; H01M 50/213; H01M 50/247; H01M 50/284; H01M 50/291

(52) U.S. Cl. CPC H01M 50/519; H01M 10/425; H01M 50/213; H01M 50/247; H01M 50/284; H01M 50/291; H01M 2010/4271; H01M 2220/30

(57) ABSTRACT

A rechargeable battery pack supplies electrical drive power to electrically driven piece of work equipment. The rechargeable battery pack has rechargeable battery cells, an FPC connector and a pack housing. The FPC connector is electrically connected to the rechargeable battery cells. The rechargeable battery cells and the FPC connector are physically arranged in the pack housing. The pack housing has guide grooves which, running side by side, are designed to guide the rechargeable battery pack for mechanical connection with the piece of work equipment. The FPC connector is physically arranged between the guide grooves and not next to the guide grooves, and/or the rechargeable battery pack has at least one cell holder, wherein the cell holder is physically arranged in the pack housing. The cell holder has at least one holding part, wherein the holding part holds the rechargeable battery cells. The cell holder has at least one spacer projection such that the pack housing, together with the at least one holding part, forms a gap, wherein the FPC connector is physically arranged in a connector space created by the gap.

### CROSS REFERENCE TO RELATED APPLICATION

This application claims priority under 35 U.S.C. § 119 from German Patent Application No. 10 2025 114 359.5, filed Apr. 11, 2025, the entire disclosure of which is herein expressly incorporated by reference.

### FIELD OF APPLICATION

The invention relates to a rechargeable battery pack for supplying electrical drive power to an electrically driven piece of work equipment and to a system comprising the rechargeable battery pack.

### PROBLEM AND SOLUTION

The invention is based on the object of providing a rechargeable battery pack for supplying electrical drive power to an electrically driven piece of work equipment, and a system comprising the rechargeable battery pack which, in particular each of which, have improved properties.

The invention solves this problem by providing a rechargeable battery pack as described in the independent claim. Advantageous developments of the invention are described in the dependent claims.

The rechargeable battery pack according to the invention is designed, in particular, to supply electrical drive power to an electrically driven piece of work equipment. The rechargeable battery pack comprises rechargeable battery cells, an FPC connector and a pack housing. The FPC connector is electrically connected to the rechargeable battery cells. The rechargeable battery cells and the FPC connector are physically arranged in the pack housing.

In addition, the pack housing has guide grooves. The guide grooves running side by side are designed to guide the rechargeable battery pack for mechanical connection with the piece of work equipment. The FPC connector is physically arranged, in particular only, between the guide grooves and not next to the guide grooves.

Again in addition or as an alternative, the rechargeable battery pack has at least one cell holder. At least the cell holder is physically arranged in the pack housing. At least the cell holder has at least one holding part. At least the holding part holds the rechargeable battery cells. At least the cell holder has at least one spacer projection such that the pack housing, together with the at least one holding part, forms a gap. The FPC connector is physically arranged in at least one connector space created by means of the gap.

This, in particular the physical arrangement of the FPC connector between the guide grooves and not next to the guide grooves, enables a space-saving design of the rechargeable battery pack.

In addition or as an alternative, this, in particular at least the spacer projection such that the pack housing, together with the at least one holding part, forms the gap, wherein the FPC connector is physically arranged in at least the connector space created by means of the gap, makes it possible to prevent the FPC connector from shearing off in the arrangement in the pack housing.

In particular, the term “battery pack” may be used synonymously for the term “rechargeable battery pack”.

The rechargeable battery pack may be mobile or portable.

Mobile may mean a mass of at most 50 kg (kilograms), in particular at most 20 kg, in particular at most 10 kg, in particular at most 5 kg, and/or at least 0.2 kg, in particular at least 0.5 kg, in particular at least 1 kg, in particular at least 2 kg, in particular 0.8-1.9 kg.

The rechargeable battery pack and/or the rechargeable battery cells may be rechargeable.

The rechargeable battery cells may each be electrochemical-based individual rechargeable storage elements for electrical energy. In addition or as an alternative, the battery cells may be lithium-ion battery cells. Again in addition or as an alternative, the battery cells may be identical, in particular of the same type and/or construction. Again in addition or as an alternative, an, in particular respective, cell voltage, in particular cell rated voltage, of an, in particular respective, one of the rechargeable battery cells may be at least 2 V (volts) and/or at most 4 V, in particular 3.6 V.

The supply may be automatic.

The term “configured”, “set up” or “intended” or the phrase “programmed to perform the function/s of” may be used synonymously for the term “designed”.

The term “comprises” may be used synonymously for the term “has” or “contains”.

The FPC connector may not be a cable harness and/or the rechargeable battery pack may not have a cable harness.

The term “flexible circuit board” or the term “conductor film” may be used synonymously for the term “FPC connector” (FPC short for flexible printed circuit).

The pack housing may be an external pack housing.

The guide grooves may be accessible from outside the pack housing, elongate recesses in the pack housing and/or not protrusions, in particular not rails, to the outside.

The pack housing may have the guide grooves on exactly one housing side, in particular a first housing circumferential side.

The phrase “parallel to one another” may be used synonymously for the term “side by side”.

The FPC connector and the guide grooves may be parallel to one another.

The FPC connector may be physically arranged within an intermediate space between the guide grooves and not outside the intermediate space.

The FPC connector may have a maximum width of at most 100 mm (millimetres), in particular 47 mm, and in particular a minimum width of at most 10 mm, in particular 3.5 mm.

The FPC connector may have, in particular exactly, one, in particular flexible, connector circuit board. A connector board plane of the connector circuit board may correspond to, in particular equate to, a groove plane defined by the guide grooves.

The pack housing may not have a spacer protrusion.

The holding part and the spacer protrusion may be integrally formed with one another.

The spacer protrusion may protrude from the holding part from below to above.

The FPC connector may be physically arranged above the holding part and/or below the pack housing.

From above to below may be in the direction of the rechargeable battery cells.

The term “external” may be used synonymously for the term “above”.

The term “internal” may be used synonymously for the term “below”.

The component of the term “nose” or “elevation” may be used synonymously for the component of the term “projection”.

The term “clearance” or “cavity” may be used synonymously for the term “connector space”.

The term “extends” or the term “runs” may be used synonymously for the term “is physically arranged”.

The gap may be greater than zero.

Reference is also made to the specialist literature.

In one development of the invention, the rechargeable battery has a power rail. The power rail is designed to transmit the drive power. The power rail is physically arranged in the pack housing. The power rail runs next to the FPC connector and/or below a guide groove of the guide grooves. This enables a particularly space-saving design of the rechargeable battery pack. In particular, the term “busbar” may be used synonymously for the term “power rail”. In addition or as an alternative, the power rail may be electrically conductive. Again in addition or as an alternative, the transmission may be automatic. In addition or as an alternative, the power rail may run parallel to the FPC connector and/or the guide grooves. In addition or as an alternative, the power rail may be electrically connected to a battery management system of the rechargeable battery pack and/or an electrical pack power contact of the rechargeable battery pack.

In one development of the invention, the rechargeable battery pack comprises at least the electrical pack power contact, in particular a plug connector. The pack power contact is designed to touch an electrical equipment power contact of the piece of work equipment for transmitting the drive power. In addition or as an alternative, the rechargeable battery pack, in particular the FPC connector, has at least one electrical pack data contact, in particular a plug connector. The pack data contact is designed to touch an electrical equipment data contact of the piece of work equipment for transmitting data between the rechargeable battery pack and the piece of work equipment. The rechargeable battery pack has a contact plate. The contact plate is physically arranged in the pack housing. The contact plate has a carrier part. The carrier part carries the pack power contact and/or the pack data contact. The contact plate has at least one spacer projection such that the pack housing, together with the carrier part, forms the gap. This makes it possible to particularly easily prevent the FPC connector from shearing off. In particular, the pack power contact and/or the pack data contact may be physically arranged in the pack housing. In particular, the pack housing may have at least one feed-through aperture, in particular at least one slot, for feeding through the pack power contact, the equipment power contact, the pack data contact and/or the equipment data contact for the contact-making process. In particular, the pack power contact and/or the pack data contact may be physically arranged in the pack housing under and/or behind the at least one feed-through aperture, in particular in the direction from the outside to the inside. In addition or as an alternative, the transmission may be automatic. Again in addition or as an alternative, the data relating to the supply of the drive power to the piece of work equipment may be electrical measurement signals and/or states of charge of the rechargeable battery cells and/or have values. Again in addition or as an alternative, the battery management system may be designed to send data to the piece of work equipment and/or to receive data from the piece of work equipment. The FPC connector may have at least one electrical data conductor path. At least the data conductor path may provide at least one electrical data connection of the battery management system to the pack data contact. At least the data conductor path may be designed to transmit the data, in particular to send and/or receive the data. In particular, the data conductor path may extend up to the battery management system and/or up to the pack data contact. In addition or as an alternative, the contact plate may be secured to the cell holder. Again in addition or as an alternative, the contact plate may be electrically insulating or have an insulation function (isolation potentials) and/or a flame retardant function (flame retardant material, in particular in contrast to the pack housing). Again in addition or as an alternative, the carrier part and the spacer projection may be integrally formed with one another. Again in addition or as an alternative, the spacer protrusion may protrude from the carrier part from below to above. Again in addition or as an alternative, the FPC connector may be physically arranged above the carrier part. Again in addition or as an alternative, the term “contact” may be used synonymously for the term “touch”.

In one development of the invention, at least the cell holder, and in particular the contact plate, has notches. The guide grooves, and in particular the power rail, are physically arranged in the notches. This enables a particularly space-saving design of the rechargeable battery pack. In particular, the term “mating contours” or “indentations” can be used synonymously for the term “notches”.

In one development of the invention, at least the spacer projection and/or the connector space is/are physically arranged, in particular only, between the guide grooves and not next to the guide grooves. In addition or as an alternative, the FPC connector and/or the connector space is/are physically arranged, in particular only, between the spacer projections and not next to the spacer projections. This enables a particularly space-saving design of the rechargeable battery pack. In particular, the spacer projection and the guide grooves may run parallel to one another. In addition or as an alternative, the spacer protrusion may be physically arranged within the intermediate space and not outside the intermediate space. In addition or as an alternative, the connector space may be the intermediate space. Again in addition or as an alternative, the spacer projections may be next to one another. Again in addition or as an alternative, the FPC connector and the spacer projections may run parallel to one another. Again in addition or as an alternative, the connector plate plane may correspond to, in particular equate to, a projection plane defined by the spacer projections.

In one development of the invention, the pack housing has a housing container. The housing container has an insertion opening. The rechargeable battery cells, the FPC connector and at least the cell holder, and in particular the contact plate, are inserted into the housing container through the insertion opening. At least the cell holder has at least the spacer projection, and in particular the contact plate has at least the spacer projection, such that a container wall of the housing container, together with the at least one holding part, and in particular the carrier part, forms the gap. In particular, the pack housing has a housing cover. The housing cover closes the insertion opening of the housing container. This makes it possible to prevent the FPC connector from shearing off when it is inserted into the housing container. In particular, during or at the point of insertion of the housing cover, the insertion opening may not close or the housing cover may be removed from the housing container. After the insertion in terms of time, the housing cover may close the insertion opening or the housing cover may be close to the housing container. In addition or as an alternative, the housing cover may be mechanically connected to the housing container. Again in addition or as an alternative, the housing cover and the housing container may adjoin one another or make contact with one another in a connecting or insertion direction, in particular a longitudinal direction. In particular, the housing cover may be shorter in the connection direction than the housing container. In addition or as an alternative, the guide grooves may run in the connecting direction.

In one development of the invention, the rechargeable battery pack has an, in particular cuboid, cell block. The cell block comprises the rechargeable battery cells. The cell block is physically arranged in the pack housing. The FPC connector and the guide grooves are physically arranged on, in particular at, a block side, in particular a block circumferential side, of the cell block parallel to the block side. In particular, the cell block, in particular the cuboid shape thereof, is formed by at least the cell holder, in particular at least the holding part, and in particular the held rechargeable battery cells. This enables a particularly space-saving design of the rechargeable battery pack. In particular, the term “cell assembly” may be used synonymously for the term “cell block”. In addition or as an alternative, the cell block may be of parallelepipedal shape. Again in addition or as an alternative, the connector circuit board may be physically arranged with its connector plate plane on, in particular at, the block side parallel to the block side. Again in addition or as an alternative, the block circumferential side may be a first block circumferential side. Again in addition or as an alternative, the term “outer side” may be used synonymously for the term “block circumferential side”. Again in addition or as an alternative, from above to below may be in the direction of the cell block. Again in addition or as an alternative, the term “defined” may be used synonymously for the term “formed”.

In one development of the invention, the rechargeable battery pack has electrical cell contactors, in particular cell contactor plates. The cell contactors are physically arranged in the pack housing. The cell contactors are electrically connected to the rechargeable battery cells. The FPC connector is electrically connected, in particular directly, to the cell contactors in each case by means of resistance welding joints. The resistance welding joints are physically arranged, in particular only, between the guide grooves and not next to the guide grooves, and in particular at least, in particular precisely, on, in particular at, the block side of the cell block parallel to the block side. This makes it possible to prevent the FPC connector from being sheared off by the cell contactors. In addition or as an alternative, this enables a particularly space-saving design of the rechargeable battery pack. In particular, the cell contactors may be electrically conductive. In addition or as an alternative, the cell contactors may be electrical cell connectors. The cell connectors may electrically connect the rechargeable battery cells to one another in series and/or in parallel. Again in addition or as an alternative, the cell contactors may be mechanically connected to the rechargeable battery cells. Again in addition or as an alternative, the FPC connector may be mechanically connected to each of the cell contactors by means of the resistance welding joints and/or the FPC connector may be secured to each of the cell contactors. Again in addition or as an alternative, the term “immediately” may be used synonymously for the term “directly”. Again in addition or as an alternative, the resistance welding joints may be physically arranged within the intermediate space and not outside the intermediate space. Again in addition or as an alternative, the cell contactors can be secured to at least the cell holder, in particular at least the holding part.

In one development of the invention, the rechargeable battery pack comprises the electrical cell contactors, in particular the cell contactor plates. The cell contactors are physically arranged in the pack housing. The cell contactors are electrically connected to the rechargeable battery cells. The FPC connector is electrically connected, in particular directly, to the each of the cell contactors by means of the resistance welding joints by means of welding electrodes from above produced. At least the cell holder, in particular at least the holding part, is formed, in particular integrally, as at least one welding support for producing the resistance welding joints. At least the cell holder is physically arranged, in particular directly, below the cell contactors and the FPC connector, in particular their resistance welding joints to one another. At least the spacer projection is physically arranged above the at least one welding support and/or next to the FPC connector. This makes it simple to produce the resistance welding joints and thus the rechargeable battery pack and/or a multi-function of the cell holder or the fact that the rechargeable battery pack may not have a separate or extra welding support, and thus a simple design of the rechargeable battery pack with few components. In particular, the welding electrodes may be, in particular precisely, two welding electrodes. In addition or as an alternative, the welding electrodes may be placed on the FPC connector. Again in addition or as an alternative, the cell holder, in particular the welding support, may be electrically insulating. Again in addition or as an alternative, the at least one welding support may be welding supports and/or flat. Again in addition or as an alternative, the term “welding substrate” may be used synonymously for the term “welding support”. Again in addition or as an alternative, the cell contactors may be physically arranged, in particular directly, below the FPC connector for producing the resistance welding joints.

In one development of the invention, the FPC connector is of elongate design and secured by means of its longitudinal ends, in particular for producing the resistance welding joints. In particular, the resistance welding joints are physically arranged between the longitudinal ends. In particular, the FPC connector is secured by way of its first longitudinal end by means of the battery management system of the rechargeable battery pack. In addition or as an alternative, in particular, the FPC connector is secured by way of its second longitudinal end by means of at least the electrical pack data contact of the rechargeable battery pack, in particular the FPC connector. This enables simple production and/or a good design of the rechargeable battery pack. In particular, the term “oblong” may be used synonymously for the term “elongate”. In addition or as an alternative, a length of the FPC connector may be greater than a width and/or a thickness of the FPC connector. Again in addition or as an alternative, secured may be mechanically secured. Again in addition or as an alternative, the term “positioned” may be used synonymously for the term “secured”. Again in addition or as an alternative, the FPC connector may be secured to a system circuit board of the battery management system.

In one development of the invention, the rechargeable battery pack comprises the, in particular cuboid, cell block. The cell block comprises the rechargeable battery cells. The cell block is physically arranged in the pack housing. The FPC connector extends, in particular with at least electrical measurement conductor paths of the FPC connector, at least on the first block circumferential side of the cell block over more than 50% (percent), in particular over at least 75%, in particular over 100%, of an extent from a first end of the block circumference side to a second end of the block circumferential side. The block circumferential side or the first end adjoins a first block front side of the cell block. The block circumferential side or the second end adjoins a second block front side of the cell block. The second block front side is located opposite the first block front side. In particular, the FPC connector extends continuously from the block circumferential side to the second block front side, and in particular a second block circumferential side of the cell block, and/or in particular from on the first block front side to the first block circumferential side. The second block circumferential side is located opposite the first block circumferential side. In particular, the cell block, in particular the cuboid shape thereof, is formed by at least the cell holder, in particular at least the holding part, and in particular the held rechargeable battery cells. This make it possible to simply design the rechargeable battery pack with few components. In particular, the cell contactors and/or the resistance welding joints may be physically arranged along the line, in particular from the first end to the second end. In addition or as an alternative, the term “front side” may be used synonymously for the term “block front side”. Again in addition or as an alternative, the battery management system may be physically arranged, in particular completely and/or precisely, on, in particular at, the first block front side. In particular, the battery management system may comprise at least, in particular precisely, the, in particular rigid, system circuit board. The system circuit board may be physically arranged with its system board plane parallel to the first block front side. Again in addition or as an alternative, the pack data contact and/or the contact plate may be physically arranged, in particular completely and/or precisely, on, in particular at, the second block front side. Again in addition or as an alternative, the connector board may be physically arranged with its connector plate plane on, in particular at, the second block front side parallel to the second block front side and/or on, in particular at, the second block circumferential side parallel to the second block circumferential side and/or on, in particular at, the first block front side parallel to the first block front side. Again in addition or as an alternative, the FPC connector may be secured to the cell contactors at least, in particular precisely, on the first block circumferential side. Again in addition or as an alternative, the term “in one piece” or the term “without a physical interruption” can be used synonymously for the term “continuous”.

In one development of the invention, the rechargeable battery pack comprises the battery management system. The battery management system is designed to detect the electrical measurement signals, in particular cell voltages, of the rechargeable battery cells. The battery management system is physically arranged in the pack housing. The FPC connector comprises at least the electrical measurement conductor paths. At least the measurement conductor paths, and in particular the cell contactors, provide at least electrical measurement connections of the battery management system to the rechargeable battery cells, in particular a measurement connection of the measurement connections of the battery management system with each rechargeable battery cell of the rechargeable battery cells. At least the measurement conductor paths, and in particular the cell contactors, are designed to transmit at least the measurement signals, in particular for detecting the measurement signals. In other words: By means of at least the measuring conductor paths, the battery management system and the rechargeable battery cells comprise at least the measurement connections to one another for transmission of at least the measurement signals. This enables the FPC connector to function. In particular, the battery management system may be electrical, in particular electronic, and/or have a measurement electronics device. In addition or as an alternative, the detection and/or transmission may be automatic. Again in addition or as an alternative, the term “measurement” may be used synonymously for the term “detection”. In addition or as an alternative, the measurement signals may be temperatures and/or have values. Again in addition or as an alternative, the cell voltages may be average voltages and/or individual cell voltages. Again in addition or as an alternative, the battery management system may be designed to determine the states of charge, in particular individual states of charge, of the rechargeable battery cells. Again in addition or as an alternative, the battery management system and the FPC connector may be completely different. Again in addition or as an alternative, the FPC connector may have an electrically insulating carrier which can carry at least the measurement conductor paths. Again in addition or as an alternative, the measurement conductor paths may be electrically conductive and/or copper conductor paths. Again in addition or as an alternative, the measurement conductor paths may, in particular each, be resistance-welded to the cell contactors. Again in addition or as an alternative, the measurement conductor paths may each extend up to the cell contactors and/or the resistance welding joints. Again in addition or as an alternative, at least the measurement conductor paths may extend up to the battery management system. Again in addition or as an alternative, the FPC connector may be secured to the battery management system. In particular, at least the measurement conductors may each be soldered to the battery management system. Again in addition or as an alternative, the battery management system may be secured to the cell holder.

In one development of the invention, the FPC connector comprises the electrically insulating carrier. The carrier has a thickness of at most 500 μm (micrometre), in particular at most 250 μm, and in particular at least 50 μm, in particular at least 150 μm, in particular 200 μm. This enables the FPC connector to be sensitive to shearing. In particular, the term “substrate” may be used synonymously for the term “carrier”. In addition or as an alternative, the carrier may carry the pack data contact and/or the data conductor path.

In one development of the invention, the rechargeable battery cells are, in particular elongate, round cells. The round cells each have cell terminals on their opposite cell front sides. In particular, the round cells are physically arranged in at least one common cell plane with their longitudinal cell axes parallel to one another. In particular, the round cells are physically arranged with their longitudinal cell axes parallel to the block circumferential side. In particular, the component of the term “contact” may be used synonymously for the component of the term “terminal”. In addition or as an alternative, the cell terminals may be physically arranged along the extent, in particular from the first end to the second end.

The system according to the invention comprises the rechargeable battery pack as previously mentioned and comprises an, in particular the, piece of work equipment and/or an electric charger. The charger is designed to supply electrical charging power to the rechargeable battery pack. In particular, the system, the piece of work equipment and/or the charger may be mobile. In addition or as an alternative, the piece of work equipment may have a work tool and/or an, in particular electric, drive motor, in particular for driving the work tool. In particular, the drive power may be for the drive motor. Again in addition or as an alternative, the piece of work equipment may be ground-guided and/or hand-operated, in particular hand-held, and/or a piece of gardening, forestry, construction and/or cultivation work equipment. In particular, the piece of work equipment may be a saw, in particular a chainsaw, or a pruner, or a hedge trimmer, or a hedge cutter, or a wood cutter, or pruning shears, or an angle grinder or a blower, or a leaf blower, or a vacuum cleaner, or a leaf vacuum, or a cleaning appliance, or a high-pressure cleaner, or a sweeper, or a sweeper roller, or a sweeping brush, or a lawnmower, or a grass trimmer, or a brush cutter, or a scarifier. Again in addition or as an alternative, the rechargeable battery pack and the piece of work equipment may be designed for electrical and/or mechanical connection to one another in a manner releasable in particular without the use of tools and/or non-destructively, in particular by way of a user. Again in addition or as an alternative, the rechargeable battery pack and the piece of work equipment and/or the charger may be designed to carry the rechargeable battery pack by way of the piece of work equipment and/or the charger and/or to remove and/or replace the rechargeable battery pack. In particular, the piece of work equipment and/or the charger may have a rechargeable battery slot which may be designed for receiving the rechargeable battery pack. Again in addition or as an alternative, the supply may be automatic.

Further advantages and aspects of the invention will become apparent from the claims and from the description of exemplary embodiments of the invention, which are explained below with reference to the figures.

### BRIEF DESCRIPTION OF THE DRAWINGS

FIG. 1 shows a perspective view of a rechargeable battery pack according to the invention for supplying electrical drive power to an electrically driven piece of work equipment without a pack housing,

FIG. 2 shows a view of a first block circumferential side of a cell block of the rechargeable battery pack,

FIG. 3 shows a view of an outer side or top side of a battery management system and an FPC connector of the rechargeable battery pack,

FIG. 4 shows a view of an inner side or bottom side of the battery management system and the FPC connector of the rechargeable battery pack, wherein the inner side is located opposite the outer side,

FIG. 5 shows another view of the inner side of the FPC connector,

FIG. 6 shows a perspective view of the rechargeable battery pack without the battery management system and without the FPC connector,

FIG. 7 shows a view of the first block circumferential side of the cell block without the battery management system and without the FPC connector,

FIG. 8 shows a perspective view of electrical cell contactors of the rechargeable battery pack,

FIG. 9 shows a view of the securing of the FPC connector to a cell contactor of the cell contactors,

FIG. 10 shows a perspective view of a cell holder of the rechargeable battery pack,

FIG. 11 shows a perspective view of a contact plate of the rechargeable battery pack,

FIG. 12 shows a view of a second block circumferential side of the cell block with a housing cover of the pack housing,

FIG. 13 shows a view of a second block front side of the cell block,

FIG. 14 shows a sectional view of the rechargeable battery pack with a housing container of the pack housing,

FIG. 15 shows a view of the second block front side of the cell block without a part of the housing container,

FIG. 16 shows a view of the second block front side of the cell block with the pack housing or a second housing front side of the pack housing,

FIG. 17 shows a view of a first housing front side of the pack housing, wherein the first housing front side is located opposite the second housing front side,

FIG. 18 shows a view of a first housing circumferential side of the pack housing,

FIGS. 19 to 21 show at least one view of at least one other housing circumferential side of the pack housing, and

FIG. 22 shows a schematic view of a system according to the invention comprising the rechargeable battery pack, the piece of work equipment and an electric charger for supplying electrical charging power to the rechargeable battery pack.

### DETAILED DESCRIPTION OF THE EXEMPLARY EMBODIMENTS

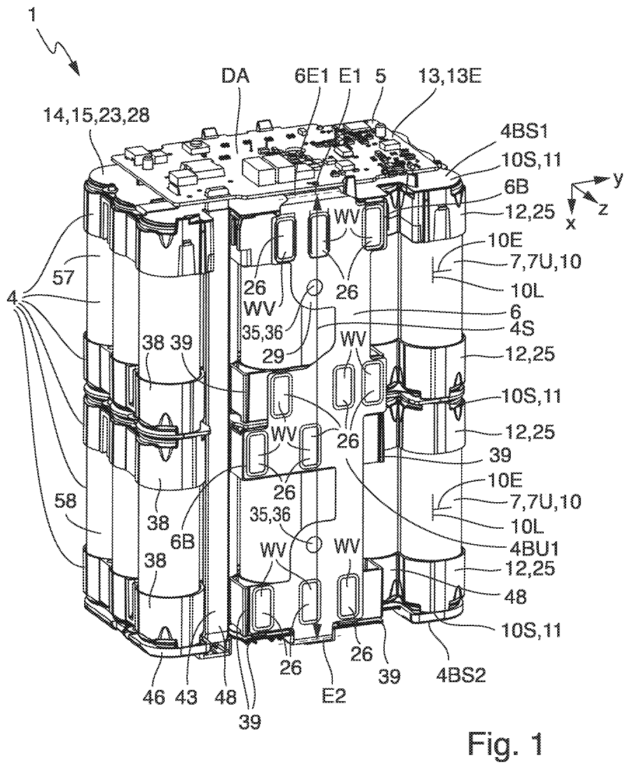

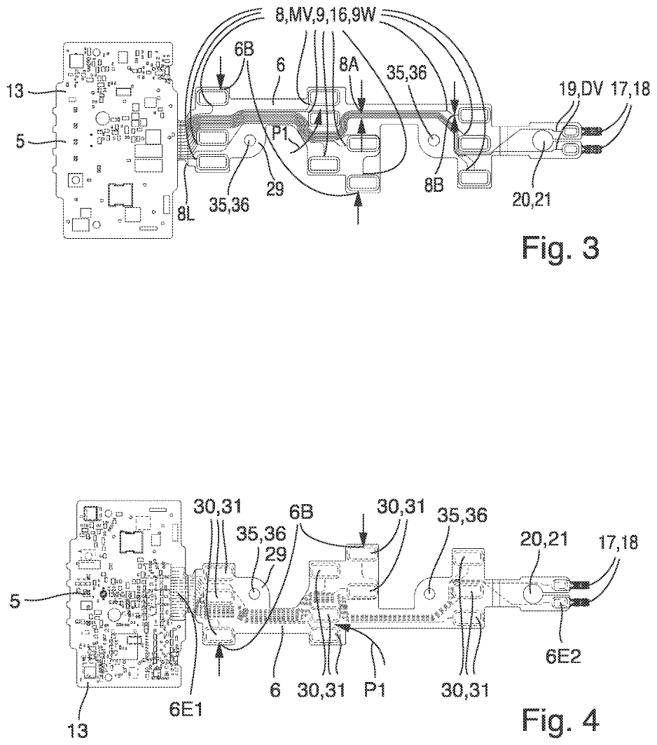

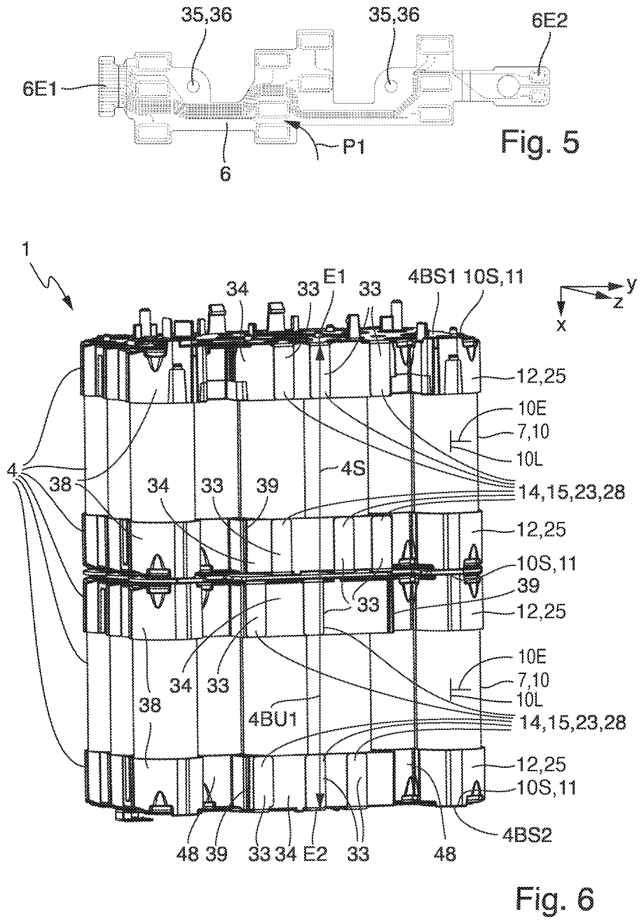

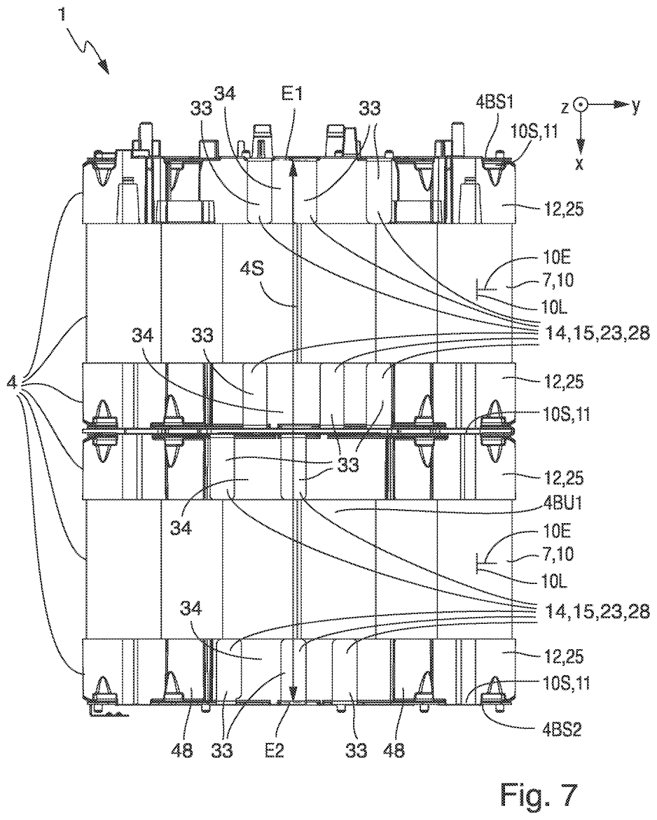

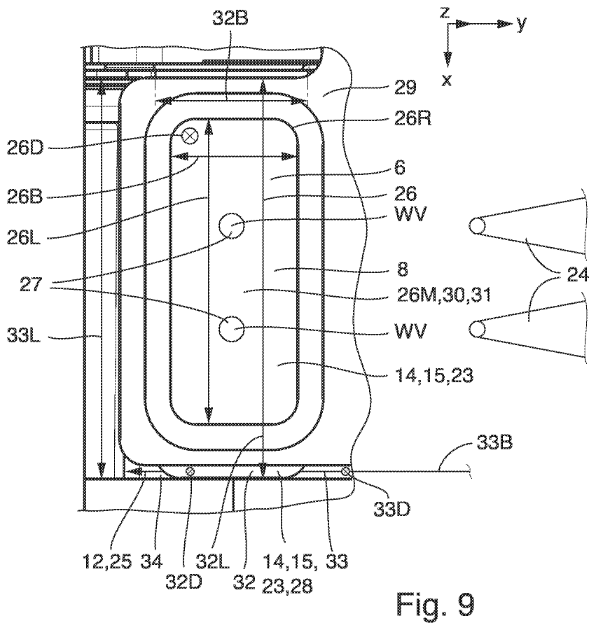

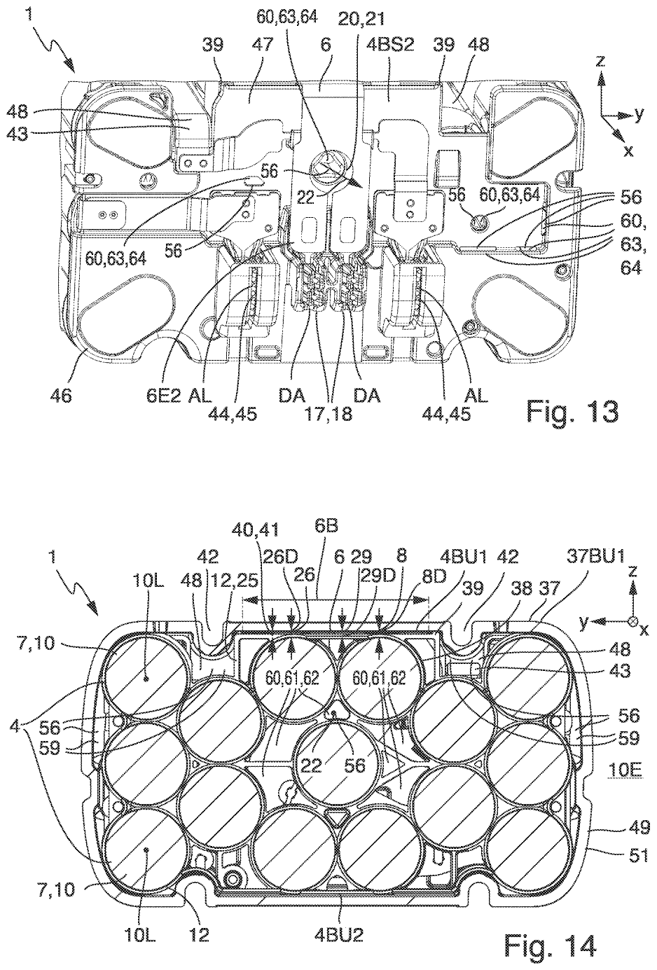

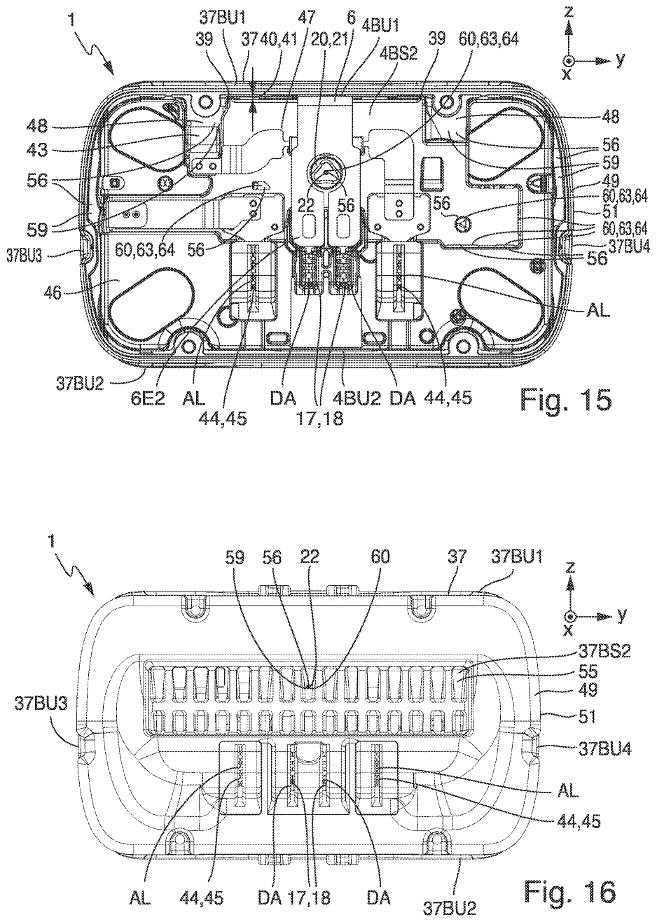

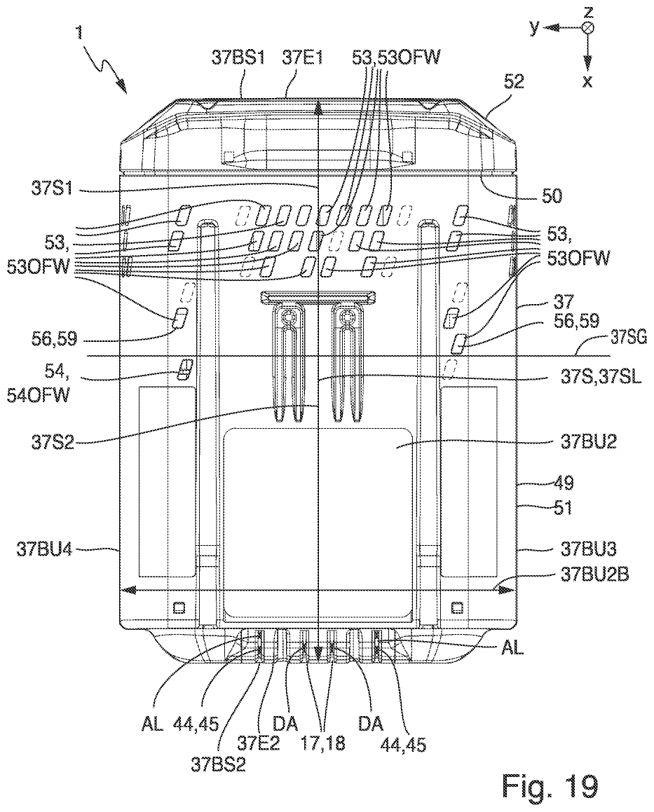

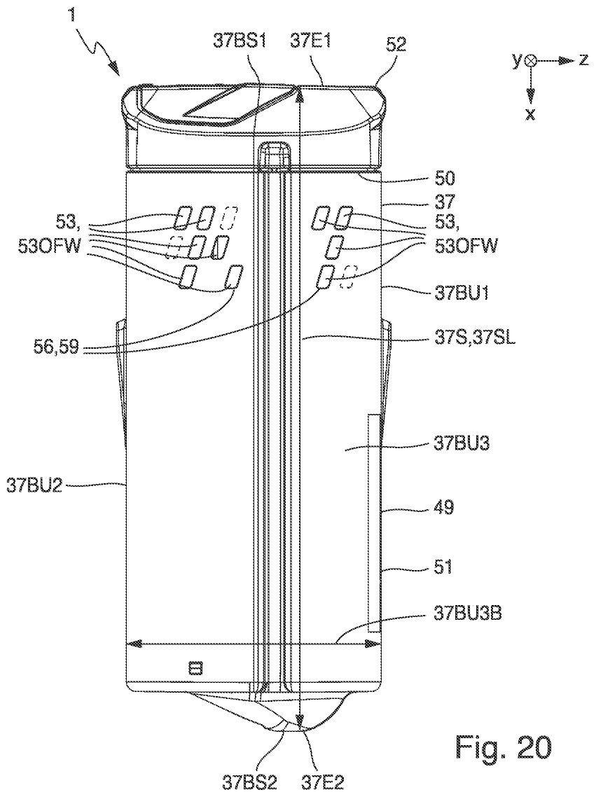

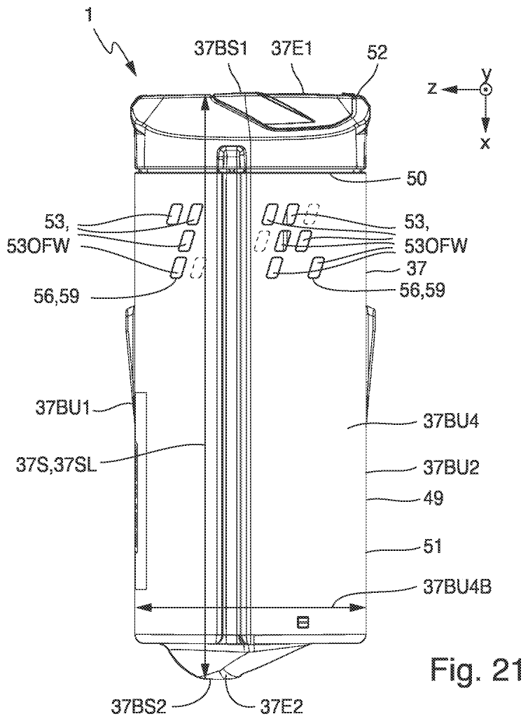

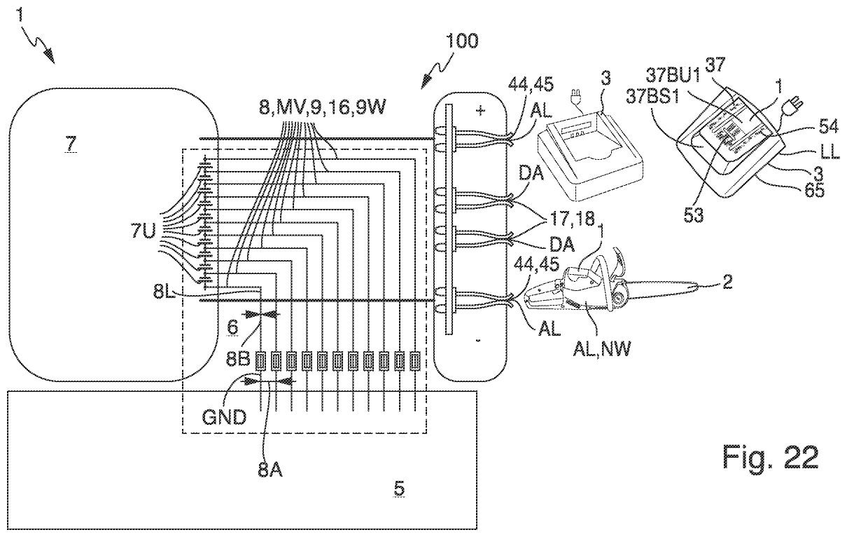

FIGS. 1, 2, 6, 7, 9 and 12 to 22 show a rechargeable battery pack 1 according to the invention. The rechargeable battery pack 1 is designed to supply, in particular supplies, electrical drive power AL to an electrically driven piece of work equipment 2, as shown in FIG. 22. The rechargeable battery pack 1 comprises rechargeable battery cells 7, an FPC connector 6 and a pack housing 37, as shown in FIGS. 3 to 5. The FPC connector 6 is electrically connected to the rechargeable battery cells 7. The rechargeable battery cells 7 and the FPC connector 6 are physically arranged in the pack housing 37.

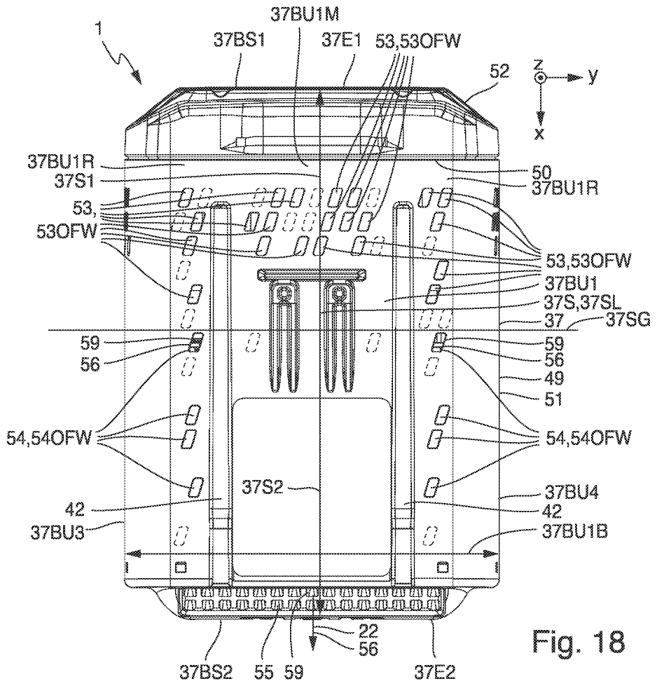

In addition, the pack housing 37 comprises guide grooves 42, as shown in FIGS. 14 and 18. The guide grooves 42 running side by side are designed to guide, in particular they guide, the rechargeable battery pack 1 for mechanical connection with the piece of work equipment 2. The FPC connector 6 is physically arranged between the guide grooves 42 and not next to the guide grooves 42.

Again in addition or as an alternative, the rechargeable battery pack 1 has at least one cell holder 12, as shown in FIGS. 1, 2, 6, 7, 9, 10, 12, 14 and 15. At least the cell holder 12 is physically arranged in the pack housing 37. At least the cell holder 12 has at least one holding part 38. At least the holding part 38 holds the rechargeable battery cells 7. At least the cell holder 12 has at least one spacer projection 39 such that the pack housing 37, together with the at least one holding part 38, forms a gap 40. The FPC connector 6 is physically arranged in at least one connector space 41 created by means of the gap 40.

FIG. 22 shows a system 100 according to the invention. The system 100 comprises the rechargeable battery pack 1 and comprises an, in particular the, piece of work equipment 2 and/or an electric charger 3. The charger 3 is designed to supply, in particular supplies, electrical charging power LL to the rechargeable battery pack 1.

In the exemplary embodiment shown, the rechargeable battery pack 1 has exactly four cell holders 12. In alternative exemplary embodiments, the rechargeable battery pack may have exactly one, exactly two, exactly three or at least five cell holders.

In detail, the rechargeable battery pack 1 has a power rail 43, as shown in FIGS. 1, 2, 13, 14 and 15. The power rail 43 is designed to transmit, in particular transmits, the drive power AL. The power rail 43 is physically arranged in the pack housing 37. The power rail 43 runs next to the FPC connector 6 and/or below a guide groove 42 of the guide grooves 42.

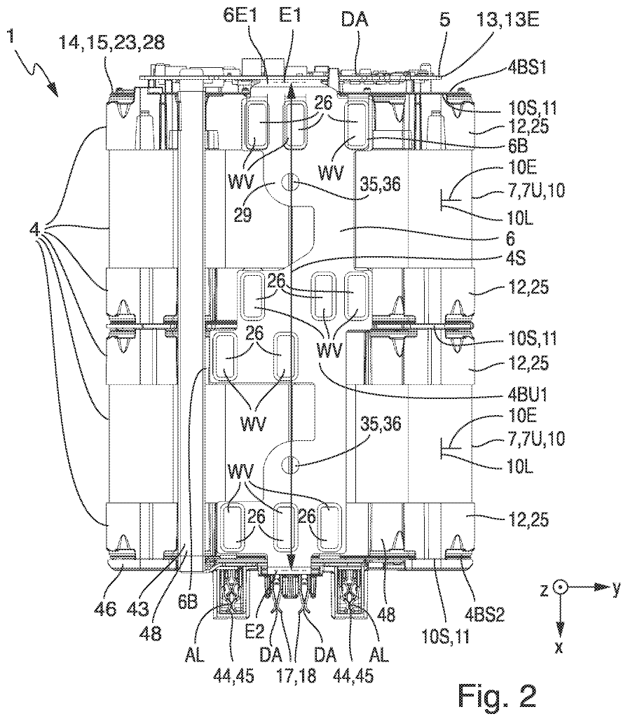

Furthermore, the rechargeable battery pack 1 has at least one electrical pack power contact 44, in particular a plug connector 45, as shown in FIGS. 2, 12, 13, 15, 16, 19 and 22. The pack power contact 44 is designed to touch an electrical equipment power contact of the piece of work equipment 2 to transmit, the drive power AL, in particular it touches and transmits. In addition or as an alternative, the rechargeable battery pack 1, in particular the FPC connector 6, has at least one electrical pack power contact 17, in particular a plug connector 18, as shown in FIGS. 1 to 4, 12, 13, 15, 16, 19 and 22. The pack data contact 17 is designed to touch an electrical equipment data contact of the piece of work equipment 2 for transmitting data DA between the rechargeable battery pack 1 and the piece of work equipment 2. The rechargeable battery pack 1 has a contact plate 46, as shown in FIG. 11. The contact plate 46 is physically arranged in the pack housing 37. The contact plate 46 has a carrier part 47. The carrier part 47 carries the pack power contact 44 and/or the pack data contact 17. The contact plate 46 has at least one spacer projection 39 such that the pack housing 37, together with the carrier part 47, forms the gap 40.

In the exemplary embodiment shown, the rechargeable battery pack 1 has exactly two pack power contacts 44 and/or exactly two pack data contacts 17. In alternative exemplary embodiments, the rechargeable battery pack may have exactly one pack power contact or at least three pack power contacts and/or exactly one pack data contact or at least three pack data contacts.

In addition, at least the cell holder 12, and in particular the contact plate 46, has notches 48, as shown in FIGS. 1, 2, 6, 7, 10, 11 and 13 to 15. The guide grooves 42, and in particular the power rail 43, are physically arranged in the notches 48.

In addition, at least the spacer projection 39 and/or the connector space 41 are physically arranged between the guide grooves 42 and not next to the guide grooves 42. In addition or as an alternative, the FPC connector 6 and/or the connector space 41 is/are physically arranged between the spacer projections 39 and not next to the spacer projections 39.

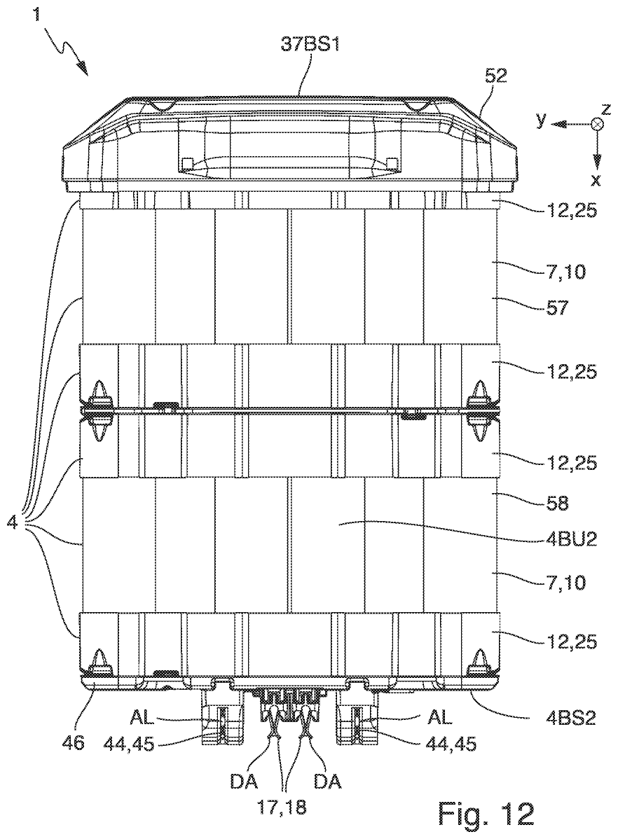

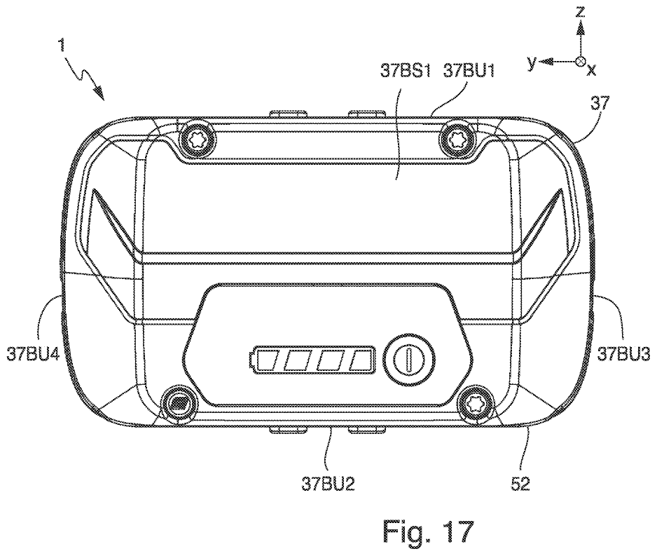

In addition, the pack housing 37 comprises a housing container 49, as shown in FIGS. 14 to 16 and 18 to 21. The housing container 49 has an insertion opening 50. The rechargeable battery cells 7, the FPC connector 6 and at least the cell holder 12 are inserted into the housing container 49 through the insertion opening 50. At least the cell holder 12 has at least the spacer projection 39 such that a container wall 51 of the housing container 49, together with the at least one holding part 38, forms the gap 40. In particular, the pack housing 37 has a housing cover 52, as shown in FIGS. 12 and 17. The housing cover 52 closes the insertion opening 50 of the housing container 49.

Furthermore, the rechargeable battery pack 1 has an, in particular cuboid, cell block 4, as shown in FIGS. 1, 2, 6, 7, 12 and 14. The cell block 4 comprises the rechargeable battery cells 7. The cell block 4 is physically arranged in the pack housing 37. The FPC connector 6 and the guide grooves 42 are physically arranged on a block side 4BU1, in particular a block circumferential side 4BU1, of the cell block 4 parallel to the block side 4BU1. In particular, the cell block 4, in particular the cuboid shape thereof, is formed by at least the cell holder 12, in particular at least the holding part 38, and in particular the held rechargeable battery cells 7.

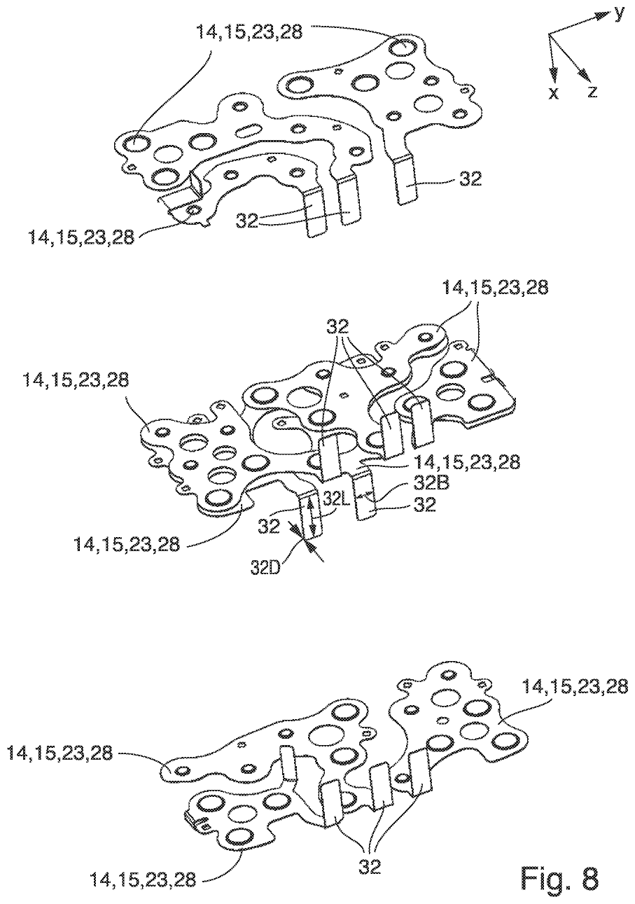

Furthermore, the rechargeable battery pack 1 comprises electrical cell contactors 23, in particular cell contactor plates 28, as shown in FIGS. 1, 2 and 6 to 9. The cell contactors 23 are physically arranged in the pack housing 37. The cell contactors 23 are electrically connected to the rechargeable battery cells 7. The FPC connector 6 is electrically connected to each of the cell contactors 23 by means of resistance welding joints WV. The resistance welding joints WV are physically arranged between the guide grooves 42 and not next to the guide grooves 42, and in particular on the block side 4BU1 of the cell block 4 parallel to the block side 4BU1.

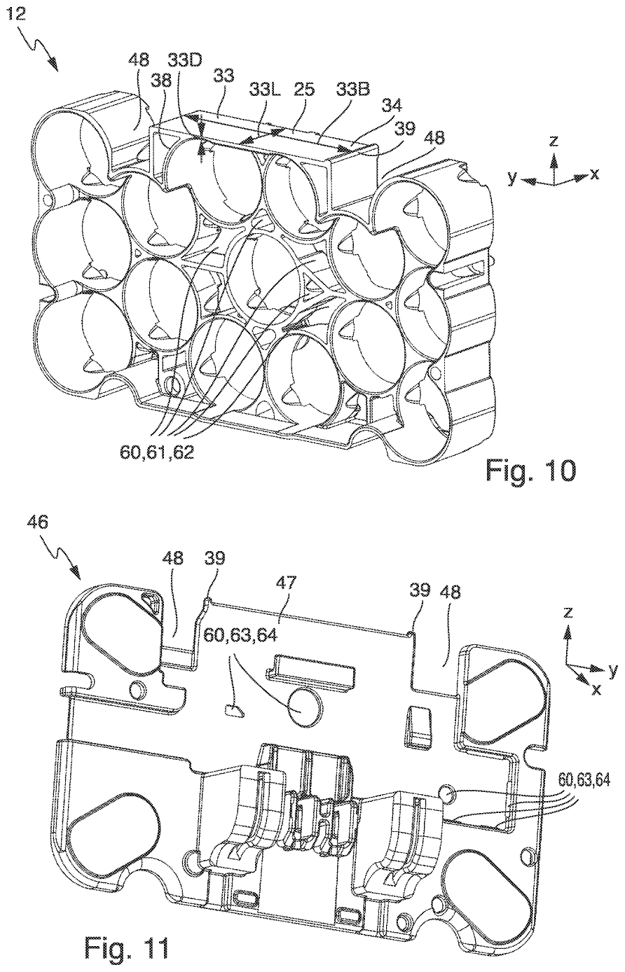

The rechargeable battery pack 1 further comprises the electrical cell contactors 23, in particular the cell contactor plates 28. The cell contactors 23 are physically arranged in the pack housing 37. The cell contactors 23 are electrically connected to the rechargeable battery cells 7. The FPC connector 6 is electrically connected to each of the cell contactors 23 by means of the resistance welding joints WV by means of welding electrodes 24 from above produced. At least the cell holder 12, in particular at least the holding part 38, is formed, in particular integrally, as at least one welding support 25 for producing the resistance welding joints WV, as shown in FIGS. 10 and 14. At least the cell holder 12 is physically arranged below the cell contactors 23 and the FPC connector 6. At least the spacer projection 39 is physically arranged above the at least one welding support 25 and/or next to the FPC connector 6.

In addition, the FPC connector 6 is of elongate design and secured by means of its longitudinal ends 6E1, 6E2, in particular for producing the resistance welding joints WV, as shown in FIGS. 1 to 5, 12, 13 and 15. In particular, the resistance welding joints WV are physically arranged between the longitudinal ends 6E1, 6E2. In particular, the FPC connector 6 is secured by way of its first longitudinal end 6E1 by means of the battery management system 5 of the rechargeable battery pack 1. In addition or as an alternative, in particular, the FPC connector 6 is secured by way of its second longitudinal end 6E2 by means of at least the electrical pack data contact 17 of the rechargeable battery pack 1, in particular the FPC connector 6.

Furthermore, the rechargeable battery pack 1 comprises the, in particular cuboid, cell block 4. The cell block 4 comprises the rechargeable battery cells 7. The cell block 4 is physically arranged in the pack housing 37. The FPC connector 6 extends at least on the first block circumferential side 4BU1 of cell block 4 over more than 50%, in particular over 100%, of an extent 4S from a first end 4E1 of the block circumferential side 4BU1 to a second end 4E2 of the block circumferential side 4BU1, as shown in FIGS. 1, 2, 6, 7 and 12 to 15. The circumferential side of the block 4BU1 adjoins a first front side of the block 4BS1 of the cell block 4. The circumferential side of the block 4BU1 adjoins a second front side of the block 4BS2 of the cell block 4. The second block front 4BS2 side is located opposite the first block front side 4BS1. In particular, the FPC connector 6 extends continuously from the block circumferential side 4BU1 to the second block front side 4BS2, and in particular, in alternative exemplary embodiments, a second block circumferential side 4BU2 of the cell block 4, and/or in particular from on the first block front side 4BS1 to the first block circumferential side 4BU1. The second block circumferential side 4BU2 is located opposite the first block circumferential side 4BU1. In particular, the cell block 4, in particular the cuboid shape thereof, is formed by at least the cell holder 12, in particular at least the holding part 38, and in particular the held rechargeable battery cells 7.

In addition, the rechargeable battery pack 1 comprises the battery management system 5, as shown in FIGS. 1 to 4 and 22. The battery management system 5 is designed to detect the electrical measurement signals 7U, in particular cell voltages, of the rechargeable battery cells 7. The battery management system 5 is physically arranged in the pack housing 37. The FPC connector 6 comprises at least electrical measurement conductor paths 8. At least the measurement conductor paths 8 provide at least electrical measurement connections MV of the battery management system 5 to the rechargeable battery cells 7. At least the measurement conductor paths 8 are designed to transmit, in particular transmit, at least the measurement signals 7U.

In the exemplary embodiment shown, the rechargeable battery pack 1 has eleven cell contactors 23 and/or the FPC connector 6 has, in particular correspondingly, in particular in a manner equating thereto, eleven measurement conductor paths 8. In alternative exemplary embodiments, the rechargeable battery pack may have fewer or more than eleven cell contactors and/or the FPC connector may, in particular correspondingly, in particular in a manner equating thereto, have fewer or more than eleven measurement conductor paths.

Furthermore, the FPC connector 6 has an electrically insulating carrier 29, as shown in FIGS. 1 to 5, 9 and 13 to 15. The carrier 9 has a thickness 29D of at most 500 μm, and in particular at least 50 μm, in particular 200 μm.

In addition, a rated, in particular electrical, voltage of the rechargeable battery pack 1 is at least 10 V, in particular at least 18 V, and/or at most 100 V, in particular at most 72 V, in particular 36 V.

In addition or as an alternative, the, in particular maximum, drive power AL and/or the, in particular maximum, charging power LL, in particular a continuous power or peak power, is at least 10 watts (W), in particular at least 100 W, in particular at least 1 kW (kilowatt), in particular at least 2 kW, and/or at most 10 kW, in particular at most 5 kW, in particular at most 4 kW, in particular 3 kW.

Again in addition or as an alternative, a maximum, in particular electrical, rated energy content of the battery pack 1 is at least 10 Wh (watt hours), in particular at least 100 Wh, in particular at least 200 Wh, and/or at most 4000 Wh, in particular at most 2000 Wh, in particular at most 1000 Wh, in particular at most 500 Wh, in particular 340 Wh.

Again in addition or as an alternative, the rechargeable battery pack 1 has a height or a thickness, in particular in the direction z, of at least 2.5 centimetres (cm) and/or at most 10 cm, in particular 5 cm, and/or a width, in particular in the direction y, of at least 5 cm and/or at most 20 cm, in particular 10 cm, and/or a depth or length, particularly in the direction x, of at least 7.5 cm and/or at most 30 cm, in particular 15 cm.

As the exemplary embodiments shown and explained above make clear, the invention provides an advantageous rechargeable battery pack for supplying electrical drive power to an electrically driven piece of work equipment and an advantageous system comprising the rechargeable battery pack, which have improved properties.

Furthermore, in addition to the claims mentioned below under “What is Claimed is”, additional or alternative claims may be:
1. Rechargeable battery pack (1) for supplying electrical drive power (AL) to an electrically driven piece of work equipment (2),
wherein the rechargeable battery pack (1) comprises an, in particular cuboid, cell block (4), a battery management system (5) and an FPC connector (6),
wherein the cell block (4) has rechargeable battery cells (7),
wherein the battery management system (5) is designed to detect electrical measurement signals (7U), in particular cell voltages, of the rechargeable battery cells (7), and
wherein the FPC connector (6) comprises at least electrical measurement conductor paths (8),
wherein at least the measurement conductor paths (8) provide at least electrical measurement connections (MV) of the battery management system (5) to the rechargeable battery cells (7), and
wherein at least the measurement conductor paths (8) are designed to transmit at least the measurement signals (7U), -wherein the FPC connector (6) has electrical overcurrent protection fuses (9) which are designed to interrupt at least the measurement conductor paths (8), in particular in each case, to protect the battery management system (5) against an electrical overcurrent, and -wherein the FPC connector (6) extends at least on a first block circumferential side (4BU1) of the cell block (4) over more than 50%, in particular over 100%, of a distance (4S) from a first end (E1) of the block circumferential side (4BU1), which adjoins a first block front side (4BS1) of the cell block (4), to a second end (E2) of the block circumferential side (4BU1), which adjoins a second block front side (4BS2) of the cell block (4), wherein the second block front side (4BS2) is located opposite the first block front side (4BS1).
2. Rechargeable battery pack (1) according to claim 1,
wherein the FPC connector (6) extends continuously from the block circumferential side (4BU1) to the second block front side (4BS2), and in particular a second block circumferential side (4BU2) of the cell block (4), wherein the second block circumferential side (4BU2) is located opposite the first block circumferential side (4BU1), and/or in particular from the first block front side (4BS1) to the first block circumferential side (4BU1).
3. Rechargeable battery pack (1) according to claim 1 or 2,
wherein the battery management system (5) is physically arranged on the first block front side (4BS1),
in particular wherein the battery management system (5) has at least one, in particular rigid, system circuit board (13) which is physically arranged with its system board plane (13E) parallel to the first block front side (4BS1).
4. Rechargeable battery pack (1) according to any one of claims 1 to 3,
wherein the FPC connector (6) is secured to the battery management system (5), in particular wherein at least the measurement conductor paths (8) are each soldered to the battery management system (5).
5. Rechargeable battery pack (1) according to any one of claims 1 to 4,
wherein the rechargeable battery pack (1) has electrical cell connectors (14), in particular cell connector plates (15), which electrically connect the rechargeable battery cells (7) to one another in series and/or in parallel, wherein the FPC connector (6) is secured to each of the cell connectors (14), in particular, wherein the measurement conductor paths (8) are each connected in a materially bonded manner, in particular resistance-welded, to the cell connectors (14).
6. Rechargeable battery pack (1) according to any one of claims 1 to 5,
wherein the overcurrent protection fuses (9) are conductor path fuses (16) which are integrally formed by at least the measurement conductor paths (8).
7. Rechargeable battery pack (1) according to claim 6,
wherein at least the conductor path fuses (16) have no taper, in particular no change in width and/or thickness, and/or no meandering structure.
8. Rechargeable battery pack (1) according to any one of claims 1 to 7,
wherein at least the measurement conductor paths (8), in particular the conductor path fuses (16), have a width (8B) of at least 50 μm, in particular at least 150 μm and/or at most 500 μm, in particular 300 μm, and/or a thickness (8D) of at least 18 μm, in particular at least 35 μm and/or at most 150 μm, in particular 70 μm, and/or a length (8L) of at least 5 mm, in particular at least 10 mm, and/or
wherein the overcurrent protection fuses (9) have an interruption current value (9W), wherein the interruption current value (9W) is at most 25 A, in particular at most 12.5 A, and/or wherein the interruption current value (9W) is lower than a rated current value (NW) of the drive power (AL), in particular wherein the interruption current value (9W) is less than 50%, in particular less than 25%, of the rated current value (NW).
9. Rechargeable battery pack (1) according to any one of claims 1 to 8,
wherein one overcurrent protection fuse (9) of the overcurrent protection fuses (9) is formed for interrupting a measurement conductor path (8) of the measurement conductor paths (8) at a ground reference potential (GND).
10. Rechargeable battery pack (1) according to any one of claims 1 to 9,
wherein the battery management system (5) is designed to send data (DA) to the piece of work equipment (2) and/or to receive data (DA) from the piece of work equipment (2),
wherein the rechargeable battery pack (1), in particular the FPC connector (6), has at least one electrical pack data contact (17), in particular a plug connector (18), which is designed to touch an electrical equipment data contact of the piece of work equipment (2), and
wherein the FPC connector (6) has at least one electrical data conductor path (19),
wherein at least the data conductor path (19) provides at least one electrical data connection (DV) of the battery management system (5) to the pack data contact (17), and
   wherein at least the data conductor path (19) is designed to transmit the data (DA).
11. Rechargeable battery pack (1) according to any one of claims 1 to 10,
wherein the FPC connector (6) has a connector aperture (20), in particular a connector hole (21), which is designed to have cooling air (22) of the rechargeable battery cells (7) flow through it, wherein at least one measurement conductor path of the measurement conductor paths and/or the data conductor path (19) extend/extends at least to the connector aperture (20).
12. Rechargeable battery pack (1) according to any one of claims 1 to 11,
wherein at least the measurement conductor paths (8) have a minimum distance (8A) between one another of at most 2 mm, in particular at most 500 μm, in particular 300 μm, and/or
wherein the FPC connector (6) has a minimum width (6B) of at most 10 mm, in particular 3.5 mm.
13. System (100) comprising:
a rechargeable battery pack (1) according to any one of claims 1 to 12, and
a piece of work equipment (2) and/or an electric charger (3) designed to supply electrical charging power (LL) to the rechargeable battery pack (1).

In addition to the claims mentioned under “What is Claimed is”, additional or alternative claims may be:
1. Rechargeable battery pack (1) for supplying electrical drive power (AL) to an electrically driven piece of work equipment (2),
wherein the rechargeable battery pack (1) has rechargeable battery cells (7), electrical cell contactors (23) and an FPC connector (6),
wherein the cell contactors (23) are electrically connected to the rechargeable battery cells (7), and
wherein the FPC connector (6) is electrically connected to the cell contactors (23) in each case by means of resistance welding joints (WV) by means of welding electrodes (24) from above produced,
characterized
in that the rechargeable battery pack (1) has at least one cell holder (12), wherein at least the cell holder (12) holds the rechargeable battery cells (7), wherein at least the cell holder (12) is formed as at least one welding support (25) for producing the resistance welding joints (WV), and wherein at least the cell holder (12) is arranged physically below the cell contactor (23) and the FPC connector (6), and/or
in that the FPC connector (6) has electrically conductive connector welding surfaces (26), wherein the connector welding surfaces (26) each extend continuously between welding points (27) of the resistance welding joints (WV) with a respective cell contactor (23) of the cell contactors (23), in particular wherein the cell contactors (23) are physically arranged below the connector welding surfaces (26) to produce the resistance welding joints (WV).
2. Rechargeable battery pack (1) according to claim 1,
wherein the rechargeable battery pack (1) has a battery management system (5), which is designed to detect electrical measurement signals (7U), in particular cell voltages, of the rechargeable battery cells (7), and
wherein the FPC connector (6) comprises at least electrical measurement conductor paths (8),
wherein at least the measurement conductor paths (8) and the cell contactors (23) provide at least electrical measurement connections (MV) of the battery management system (5) to the rechargeable battery cells (7), and
wherein at least the measurement conductor paths (8) and the cell contactors (23) are designed to transmit at least the measurement signals (7U).
3. Rechargeable battery pack (1) according to claim 1 or 2,
wherein the cell contactors (23) are electrical cell connectors (14) which electrically connect the rechargeable battery cells (7) to one another in series and/or in parallel.
4. Rechargeable battery pack (1) according to any one of claims 1 to 3,
wherein the cell contactors (23) are rigid, in particular cell contact plates (28).
5. Rechargeable battery pack (1) according to any one of claims 1 to 4,
wherein the cell holder (12) formed as the welding support (25) continuously extends below at least two cell contactors (23) of the cell contactors (23), and
wherein the FPC connector (6) does not extend continuously above or below the two cell contactors (23).
6. Rechargeable battery pack (1) according to any one of claims 1 to 5,
wherein the FPC connector (6) has an electrically insulating carrier (29) which carries the connector welding surfaces (26) at their edges (26R) and has apertures (30), in particular windows (31), below or above their centres (26M) designed for producing the resistance welding joints (WV), and
wherein the cell contactors (23) are physically arranged below the connector welding surfaces (26) to produce the resistance welding joints (WV).
7. Rechargeable battery pack (1) according to any one of claims 1 to 6,
wherein the connector welding surfaces (26) for producing the resistance welding joints (WV) have a thickness (26D) of at least 150 μm and in particular at least 18 μm, particular at least 35 μm, in particular 70 μm, and/or a width (26B) of at least 1.5 mm and/or at most 10 mm, in particular 4 mm, and/or a length (26L) of at least 2 mm and/or at most 30 mm, in particular 12 mm, and/or
wherein electrically conductive contactor welding surfaces (32) of the cell contactors (23) for producing the resistance welding joints (WV) have a thickness (32D) of more than 150 μm, and in particular at most 750 μm, in particular 300 μm, and/or a width (32B) of at least 3 mm and/or at most 15 mm, in particular 6 mm, and/or a length (32L) of at least 8 mm and/or at most 30 mm, in particular 16 mm, and/or
wherein electrically insulating support surfaces (33) of the at least one welding support (25) for producing the resistance welding joints (WV) have a thickness (33D) of more than 150 μm, and in particular at most 3 mm, in particular 0.9 mm, and/or a width (33B) of at most 43 mm.
8. Rechargeable battery pack (1) according to any one of claims 1 to 7,
wherein electrically insulating support surfaces (33) of the at least one welding support (25), in particular at least one wall (34) of at least the cell holder (12), each continuously extend below the resistance welding joints (WV) more than between the welding points (27), in particular wherein a length (33L) of the support surfaces (33) is at least as large as a length (26L, 32L) of the connector welding surfaces (26) and/or electrically conductive contactor welding surfaces (32) of the cell contactors (23) for producing the resistance welding joints (WV), and in particular wherein a width (33B) of the support surfaces (33) is at least as large as a width (26B, 32B) of the connector welding surfaces (26) and/or the contactor welding surfaces (32).
9. Rechargeable battery pack (1) according to any one of claims 1 to 8,
wherein the cell contactors (23) have electrically conductive contactor welding surfaces (32) for producing the resistance welding joints (WV) which each continuously extend below the resistance welding joints (WV) at least between the respective connector welding surface (26) of the connector welding surfaces (26), in particular wherein a length (32L) of the contactor welding surfaces (32) is at least as large as a length (26L) of the connector welding surfaces (26), and in particular wherein a width (32B) of the contactor welding surfaces (32) is at least as large as a width (26B) of the connector welding surfaces (26).
10. Rechargeable battery pack (1) according to any one of claims 1 to 9,
wherein the FPC connector (6) has at least one aperture (35), in particular a through-hole (36), at least which is designed to receive a positioning and/or orientation device for positioning and/or for orientation of the FPC connector (6) with respect to the cell contactors (23) for producing the resistance welding joints (WV).
11. Rechargeable battery pack (1) according to any one of claims 1 to 10,
wherein the FPC connector (6) is of elongate design and is secured by means of its longitudinal ends (6E1, 6E2), in particular to produce the resistance welding joints (WV), between which the resistance welding joints (WV) are physically arranged,
in particular wherein the FPC connector (6) is secured by way of its first longitudinal end (6E1) by means of a battery management system (5) of the rechargeable battery pack (1), and/or in particular wherein the FPC connector (6) is secured by way of its second longitudinal end (6E2) by means of at least one electrical pack data contact (17) of the rechargeable battery pack (1), in particular of the FPC connector (6).
12. Rechargeable battery pack (1) according to any one of claims 1 to 11,
wherein the rechargeable battery pack (1) comprises an, in particular cuboid, cell block (4) which comprises the rechargeable battery cells (7), and
wherein from above to below is in the direction (-z) of the cell block (4), and/or wherein the connector welding surfaces (26) are physically arranged at least, in particular precisely, on a block side (4BU1) of the cell block (4) parallel to the block side (4BU1), in particular a block circumferential side (4BU1).
13. Rechargeable battery pack (1) according to any one of claims 1 to 12,
wherein the rechargeable battery pack (1) has a pack housing (37), wherein the rechargeable battery cells (7), the cell contactors (23), the FPC connector (6) and at least the cell holder (12) are physically arranged in the pack housing (37), and
wherein at least the cell holder (12) has at least one holding part (38), wherein at least the holding part (38) holds the rechargeable battery cells (7), and wherein at least the cell holder (12) has at least one spacer projection (39) such that the pack housing (37), together with the at least one holding part (38), forms a gap (40), wherein the FPC connector (6) is physically arranged in at least one connector space (41) created by means of the gap (40).
14. Rechargeable battery pack (1) according to any one of claims 1 to 13,
wherein the rechargeable battery pack (1) has a pack housing (37), wherein the rechargeable battery cells (7), the cell contactors (23) and the FPC connector (6) are physically arranged in the pack housing (37), and wherein the pack housing (37) has guide grooves (42) which running side by side are designed to guide the rechargeable battery pack (1) for mechanical connection with the piece of work equipment (2), wherein the FPC connector (6) is physically arranged between the guide grooves (42) and not next to the guide grooves (42).
15. System (100) comprising:
a rechargeable battery pack (1) according to any one of claims 1 to 14, and
a piece of work equipment (2) and/or an electric charger (3) designed to supply electrical charging power (LL) to the rechargeable battery pack (1).

In addition to the claims mentioned under “What is Claimed is”, additional or alternative claims may be:
1. Rechargeable battery pack (1) for supplying electrical drive power (AL) to an electrically driven piece of work equipment (2),
wherein the rechargeable battery pack (1) has rechargeable battery cells (7) and a block-shaped, in particular cuboid, pack housing (37),
wherein the rechargeable battery cells (7) are physically arranged in the pack housing (37),
wherein the pack housing (37) has, on at least a first circumferential side of the housing (37BU1), first air inlet openings (53) along a first half (37S1) of a extent (37S) and second air inlet openings (54) along a second half (37S2) of the extent (37S) and on a, in particular exactly one, second housing front side (37BS2) air outlet openings (55) for air flow (56) in the pack housing (37) from the first air inlet openings (53) and the second air inlet openings (54) in each case past the rechargeable battery cells (7) to the air outlet openings (55) for air cooling of the rechargeable battery cells (7),
wherein the extent (37S) is from a first end (37E1) of the housing circumferential side (37BU1), which adjoins a first housing front side (37BS1) of the pack housing (37), to a second end (37E2) of the housing circumferential side (37BU1), which adjoins the second housing front side (37BS2) of the pack housing (37), wherein the second housing front side (37BS2) is located opposite the first housing front side (37BU1),
wherein the first half (37S1) adjoins the first housing front side (37BS1),
wherein the second half (37S2) adjoins the second housing front side (37BS2), and
wherein a ratio (53OFW/54OFW) of first opening surface values (53OFW) of the first air inlet openings (53) to the second opening surface values (54OFW) of the second air inlet openings (54) is in a value range of 2, in particular 5, to 20, in particular up to 15, in particular 8.
2. Rechargeable battery pack (1) according to claim 1,
wherein the first air inlet openings (53) and the second air inlet openings (54) are physically arranged and wherein the ratio (53OFW/54OFW) is such that the flow resistance values for the air flow (56) in the pack housing (37) from the first air inlet openings (53) and the second air inlet openings (54) past the rechargeable battery cells (7) to the air outlet openings (55) are identical in each case and/or that the air cooling of the rechargeable battery cells (7) is homogeneous.
3. Rechargeable battery pack (1) according to claim 1 or 2,
wherein the first air inlet openings (53) are distributed along the first half (37S1) over at least 50%, in particular 60%, of the first half (37S1) and/or physically arranged up to a boundary (37SG) with the second half (37S2), and/or
wherein the second air inlet openings (54) are distributed along the second half (37S2) over at least 50%, in particular 60%, in particular 70%, of the second half (37S2) and/or physically arranged from the boundary (37SG) with the first half (37S1) onwards, and/or
wherein the rechargeable battery cells (7) are distributed along the first half (37S1) over at least 50%, in particular 60%, in particular 70%, of the first half (37S1) and/or physically arranged up to the boundary (37SG) with the second half (37S2), and/or
wherein the rechargeable battery cells (7) are distributed along the second half (37S2) over at least 50%, in particular 60%, in particular 70%, in articular 80%, of the second half (37S2) and/or physically arranged from the boundary (37SG) with the first half (37S1) onwards.
4. Rechargeable battery pack (1) according to any one of claims 1 to 3,
wherein the rechargeable battery pack (1) has an, in particular cuboid, cell block (4), wherein the cell block (4) is physically arranged in the pack housing (37), and wherein the cell block (4) has a first sub-block (57) and a second sub-block (58), wherein the first sub-block (57) and the second sub-block (58) comprise the rechargeable battery cells (7) and are physically arranged sequentially along the extent (37S).
5. Rechargeable battery pack (1) according to any one of claims 1 to 4,
wherein at least 25%, in particular 33%, of the first air inlet openings (53) and/or at least 50%, in particular at least 65%, in particular at least 80%, of the second air inlet openings (54) are physically arranged on the first housing circumferential side (37BU1), wherein a width (37BU1B) orthogonal to the extent (37S) of the first housing circumferential side (37BU1) is at least as large as widths (37BU2B, 37BU3B, 37BU4B) of all further housing circumferential sides (37BU2, 37BU3, 37BU4) of the pack housing (37), in particular wherein a length (37SL) of the section (37S) is greater than all the widths (37BU1B, 37BU2B, 37BU3B, 37BU4B), and/or
wherein the pack housing (37) has air inlet openings (53, 54) on at least one further housing circumferential side (37BU2, 37BU3, 37BU4), in particular all other housing circumferential sides (37BU2, 37BU3, 37BU4) of the pack housing (37).
6. Rechargeable battery pack (1) according to any one of claims 1 to 5,
wherein the first air inlet openings (53) are physically arranged along a width (37BU1B) orthogonal to the extent (37S) of the first housing circumferential side (37BU1) at edges (37BU1R) and in a centre (37BU1M) of the first housing circumference side (37BU1), and/or
wherein the second air inlet openings (54) are physically arranged along the width (37BU1B) orthogonal to the extent (37S) of the first housing circumferential side (37BU1) at the edges (37BU1R) and not in the centre (37BU1M) of the first housing circumference side (37BU1).
7. Rechargeable battery pack (1) according to any one of claims 1 to 6,
wherein the rechargeable battery pack (1) comprises an, in particular cuboid, cell block (4), wherein the cell block (4) comprises the rechargeable battery cells (7), and
wherein the pack housing (37) is formed and wherein the cell block (4) is formed and physically arranged in the pack housing (37) such that at least one air duct (59) between the pack housing (37) and the cell block (4), in particular the rechargeable battery cells (7), passes the cell block (4) at least partially along the extent (37S), in particular on at least the first housing circumferential side (37BU1), and in particular at least one further housing circumferential side (37BU2, 37BU3, 37BU4) of the pack housing (37), in particular all other housing circumferential sides (37BU2, 37BU3, 37BU4) of the pack housing (37), is formed for the air flow (56).
8. Rechargeable battery pack (1) according to any one of claims 1 to 7,
wherein the rechargeable battery pack (1) comprises an, in particular cuboid, cell block (4), wherein the cell block (4) comprises the rechargeable battery cells (7), and wherein the cell block (4) is formed and physically arranged in the pack housing (37) such that at least one air duct (60) is formed for the air flow (56) through the cell block (4) at least partially along the extent (37S), in particular up to the second housing front side (37BS2).
9. Rechargeable battery pack (1) according to claim 8,
wherein the rechargeable battery pack (1) has at least one cell holder (12), a contact plate (46) and/or an FPC connector (6), wherein at least the cell holder (12), the contact plate (46) and/or the FPC connector (6) is/are physically arranged in the pack housing (37) on the cell block (4) and/or on the second housing front side (37BS2), in particular parallel to the second housing front side (37BS2),
wherein at least the cell holder (12) holds the rechargeable battery cells (7), and wherein the cell holder (12) has a holder aperture (61), in particular a holder hole (62), wherein the air duct (60) is formed through at least the holder aperture (61), and/or
wherein the contact plate (46) carries at least one electrical pack power contact (44) and/or at least one electrical pack data contact (17) of the rechargeable battery pack (1), and wherein the contact plate (46) has a plate aperture (63), in particular a plate hole (64), wherein the air duct (60) is formed through at least the plate aperture (63), and/or
wherein the FPC connector (6) has a connector aperture (20), in particular a connector hole (21), wherein the air duct (60) is formed through the at least one connector aperture (20), wherein at least one measurement conductor path and/or a data conductor path (19) of the FPC connector (6) extend/extends at least to the connector aperture (20).
10. Rechargeable battery pack (1) according to claim 9,
wherein the holder aperture (61), the plate aperture (63), the connector aperture (20) and the air outlet openings (55) are arranged sequentially along the extent (37S).
11. Rechargeable battery pack (1) according to any one of claims 1 to 10,
wherein the rechargeable battery pack (1) has at least one electrical pack power contact (44), in particular a plug connector (45), wherein the pack power contact (44) is designed to make contact with an electrical equipment power contact of the piece of work equipment (2) for transmitting the drive power (AL), and/or wherein the rechargeable battery pack (1) has at least one electrical pack data contact (17), in particular a plug connector (18), wherein the pack data contact (17) is designed to make contact with an electrical equipment data contact of the piece of work equipment (2) for transmitting data (DA) between the rechargeable battery pack (1) and the piece of work equipment (2), and
wherein the pack power contact (44) and/or the pack data contact (17) are/is physically arranged on, in particular precisely, the second housing front side (37BS2), in particular further away from the first housing circumferential side (37BU1) than the air outlet openings (55).
12. Rechargeable battery pack (1) according to any one of claims 1 to 11,
wherein the rechargeable battery cells (7) are, in particular elongate, round cells (10), in particular wherein the round cells (10) are physically arranged with their longitudinal cell axes (10L) parallel to the extent (37S), and in particular parallel to one another in at least one common cell plane (10E).
13. Rechargeable battery pack (1) according to any one of claims 1 to 12,
wherein the pack housing (37) has a housing container (49) which has an insertion opening (50) through which the rechargeable battery cells (7) are inserted into the housing container (49), and
wherein the pack housing (37) has a housing cover (52) which closes the insertion opening (50) of the housing container (49),
wherein the housing container (49) and not the housing cover (52) comprises the first air inlet openings (53), the second air inlet openings (54) and the air outlet openings (55),
in particular wherein the housing cover (52) and the housing container (49) are physically arranged sequentially along the extent (37S).
14. System (100) comprising:
a rechargeable battery pack (1) according to any one of claims 1 to 13, and
a piece of work equipment (2) and/or an electric charger (3) designed to supply electrical charging power (LL) to the rechargeable battery pack (1).
15. System (100) according to claim 14,

-wherein the piece of work equipment and/or the charger (3) and the rechargeable battery pack (1) are designed to receive the rechargeable battery pack (1) by way of the piece of work equipment and/or the charger (3) and wherein the piece of work equipment and/or the charger (3) have/has a fan (65) such that the fan (65) is designed to generate the air flow (56) in the pack housing (37), wherein the fan (65) is designed to suck cooling air (22) out of the air outlet openings (55) of the rechargeable battery pack (1) received by way of the piece of work equipment and/or the charger (3), and in particular such that the first air inlet openings (53) and the second air inlet openings (54) are free for suction into the first air inlet openings (53) and the second air inlet openings (54) on at least the first housing circumferential side (37BU1).

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A rechargeable battery pack for supplying electrical drive power to an electrically driven piece of work equipment, comprising:
rechargeable battery cells;
an FPC connector; and
a pack housing,
wherein the FPC connector is electrically connected to the rechargeable battery cells,
wherein the rechargeable battery cells and the FPC connector are physically arranged in the pack housing,
wherein the pack housing has guide grooves which, running side by side, are configured to guide the rechargeable battery pack for mechanical connection with the piece of work equipment, wherein the FPC connector is physically arranged between the guide grooves and not next to the guide grooves, and/or
wherein the rechargeable battery pack has at least one cell holder, wherein the cell holder is physically arranged in the pack housing, wherein the cell holder has at least one holding part, wherein the holding part holds the rechargeable battery cells, and wherein the cell holder has at least one spacer projection such that the pack housing, together with the holding part, forms a gap, wherein the FPC connector is physically arranged in a connector space created by the gap.

2. The rechargeable battery pack according to claim 1, further comprising:
a power rail,
wherein the power rail is designed to transmit the drive power,
wherein the power rail is physically arranged in the pack housing, and
wherein the power rail runs next to the FPC connector and/or below a guide groove of the guide grooves.

3. The rechargeable battery pack according to claim 1, further comprising:
(i) at least one electrical pack power contact, wherein the pack power contact is designed to touch an electrical equipment power contact of the piece of work equipment for transmitting the drive power; and/or (ii) at least one electrical pack data contact, wherein the pack data contact is designed to touch an electrical equipment data contact of the piece of work equipment for transmitting data between the rechargeable battery pack and the piece of work equipment;
and
a contact plate, wherein the contact plate is physically arranged in the pack housing, wherein the contact plate has a carrier part, wherein the carrier part carries the pack power contact and/or the pack data contact, and wherein the contact plate has the at least one spacer projection such that the pack housing, together with the carrier part, forms the gap.

4. The rechargeable battery pack according to claim 1,
wherein the cell holder has notches in which the guide grooves are physically arranged.

5. The rechargeable battery pack according to claim 1,
wherein the spacer projection and/or the connector space is/are physically arranged between the guide grooves and not next to the guide grooves, and/or
wherein the FPC connector and/or the connector space is/are physically arranged between spacer projections and not next to the spacer projections.

6. The rechargeable battery pack according to claim 1,
wherein the pack housing has a housing container which has an insertion opening through which the rechargeable battery cells, the FPC connector and the cell holder are inserted into the housing container,
wherein the cell holder comprises at least the spacer projection such that a container wall of the housing container, together with the at least one holding part, forms the gap.

7. The rechargeable battery pack according to claim 6,
wherein the pack housing has a housing cover which closes the insertion opening of the housing container.

8. The rechargeable battery pack according to claim 1,
wherein the rechargeable battery pack has a cuboid, cell block, wherein the cell block comprises the rechargeable battery cells, and wherein the cell block is physically arranged in the pack housing, and
wherein the FPC connector and the guide grooves are physically arranged on a block side of the cell block parallel to the block side.

9. The rechargeable battery pack according to claim 8,
wherein the cuboid cell block is formed by the holding part and the held rechargeable battery cells.

10. The rechargeable battery pack according to claim 1, further comprising:
electrical cell contactors, wherein the cell contactors are physically arranged in the pack housing, and wherein the cell contactors are electrically connected to the rechargeable battery cells,
wherein the FPC connector is electrically connected to the cell contactors in each case by resistance welding joints, and
wherein the resistance welding joints are physically arranged between the guide grooves and not next to the guide grooves.

11. The rechargeable battery pack according to claim 1, further comprising:
electrical cell contactors wherein the cell contactors are physically arranged in the pack housing, and wherein the cell contactors are electrically connected to the rechargeable battery cells,
wherein the FPC connector is electrically connected to the cell contactors in each case by resistance welding joints produced by way of welding electrodes from above,
wherein the cell holder is formed as at least one welding support for producing the resistance welding joints, and wherein the cell holder is arranged physically below the cell contactor and the FPC connector, and
wherein the spacer projection is physically arranged above the at least one welding support and/or next to the FPC connector.

12. The rechargeable battery pack according to claim 1,
wherein the FPC connector is of an elongate design and is secured by its longitudinal ends between which the resistance welding joints are physically arranged.

13. The rechargeable battery pack according to claim 12,
wherein the FPC connector is secured by way of a first longitudinal end by a battery management system of the rechargeable battery pack, and/or
wherein the FPC connector is secured by way of a second longitudinal end by at least one electrical pack data contact of the FPC connector.

14. The rechargeable battery pack according to claim 1,
wherein the rechargeable battery pack has a cuboid cell block, wherein the cell block comprises the rechargeable battery cells, and wherein the cell block is physically arranged in the pack housing, and
wherein the FPC connector extends at least on a first block circumferential side of the cell block over more than 50% of an extent from a first end of the block circumferential side, which adjoins a first block front side of the cell block, to a second end of the block circumferential side, which adjoins a second block front side of the cell block, wherein the second block front side is located opposite the first block front side.

15. The rechargeable battery pack according to claim 14,
wherein the FPC connector extends continuously from the block circumferential side to a second block circumferential side of the cell block, wherein the second block circumferential side is located opposite the first block circumferential side, and/or from the first block front side to the first block circumferential side, and
wherein the cuboid cell block is formed by the holding part and the held rechargeable battery cells.

16. The rechargeable battery pack according to claim 1, further comprising:
a battery management system, wherein the battery management system is designed to detect electrical measurement signals of the rechargeable battery cells, and wherein the battery management system is physically arranged in the pack housing, and
wherein the FPC connector comprises electrical measurement conductor paths,
wherein the measurement conductor paths provide electrical measurement connections of the battery management system to the rechargeable battery cells, and
wherein the measurement conductor paths are designed to transmit at least the measurement signals.

17. The rechargeable battery pack according to claim 1,
wherein the FPC connector has an electrically insulating carrier which has a thickness of at most 500 μm and at least 50 μm.

18. A system comprising:
the rechargeable battery pack according to claim 1; and
the piece of work equipment and/or an electric charger designed to supply electrical charging power to the rechargeable battery pack.
